(19) United States
(12) Patent Application Publication
(10) Pub. No.: US 2020/0302199 A1
(43) Pub. Date: Sep. 24, 2020

(54) VEHICLE CONTROL DEVICE, MONITORING SYSTEM, VEHICLE CONTROL METHOD, AND STORAGE MEDIUM

(71) Applicant: HONDA MOTOR CO., LTD., Tokyo (JP)

(72) Inventors: Junpei Noguchi, Wako-shi (JP); Yasushi Shoda, Wako-shi (JP); Yuki Hara, Wako-shi (JP); Ryoma Taguchi, Tokyo (JP); Yuta Takada, Tokyo (JP)

(21) Appl. No.: 16/804,043

(22) Filed: Feb. 28, 2020

(30) Foreign Application Priority Data
Mar. 19, 2019 (JP) 2019-051582

(51) Int. Cl. G06K 9/00; B60W 50/14

(52) U.S. Cl. CPC G06K 9/00832; B60W 30/06; B60W 50/14

(57) ABSTRACT

A vehicle control device includes a vicinity situation recognizer configured to recognize a vicinity situation of a vehicle, and a driving controller configured to perform driving control on steering and acceleration or deceleration of the vehicle on the basis of a vicinity situation recognized by the vicinity situation recognizer, in which, in automated entrance processing for causing the vehicle to enter a parking lot with the driving control after a predetermined event of the vehicle, the driving controller is configured to cause the vehicle to travel with a first behavior in a first predetermined period from a first timing at which the vehicle has started to a second timing at which a predetermined condition is satisfied, and cause the vehicle to travel with a second behavior in which a proceeding distance per unit time is longer than with the first behavior.

### CROSS-REFERENCE TO RELATED APPLICATION

Priority is claimed on Japanese Patent Application No. 2019-051582, filed Mar. 19, 2019, the content of which is incorporated herein by reference.

### BACKGROUND

### Field

The present invention relates to a vehicle control device, a monitoring system, a vehicle control method, and a storage medium.

### Description of Related Art

In recent years, research on automatic controlling of vehicles has been conducted. An automated driving vehicle includes an imager that captures an image of at least one portion in a vicinity of the vehicle, a storage which stores user image information on a user of the vehicle, and gesture image information related to one or a plurality of gestures indicating a predetermined vehicle operation, and a controller that collates an image captured by the imager with the user image information, identifies a gesture of the user based on the captured image and the gesture image information on a condition that the user is present in the vicinity of the vehicle, and automatically controls the vehicle such that a vehicle operation indicated by the identified gesture is executed (Japanese Unexamined Patent Application, First Publication No. 2017-121865).

However, the automated driving vehicles described above may not care for the users in some cases.

### SUMMARY

The present invention has been made in view of such circumstances, and an object thereof is to provide a vehicle control device, a monitoring system, a vehicle control method, and a storage medium which can care for a user.

A vehicle control device, a monitoring system, a vehicle control method, and a storage medium have adopted the following configuration.

(1): A vehicle control device according to one aspect includes a vicinity situation recognizer configured to recognize a vicinity situation of a vehicle, and a driving controller configured to perform driving control on steering and acceleration or deceleration of the vehicle on the basis of the vicinity situation recognized by the vicinity situation recognizer, in which, in processing of the driving control after a predetermined event of the vehicle, the driving controller is configured to cause the vehicle to travel with a first behavior in a first predetermined period from a first timing at which the vehicle has started after the predetermined event to a second timing at which a predetermined condition is satisfied, and cause the vehicle to travel with a second behavior in which a proceeding distance of the vehicle per unit time is longer than with the first behavior after the predetermined period has elapsed.

(2): In the aspect of (1) described above, the predetermined event is an event in which one or more users of the vehicle get off the vehicle, the driving controller is configured to cause the vehicle to travel with the first behavior in the first predetermined period and cause the vehicle to travel with the second behavior after the first predetermined period has elapsed in automated entrance processing for causing the vehicle to enter a parking lot with the driving control after the predetermined event, the first behavior is a behavior in which the vehicle travels at a first speed, and the second behavior is a behavior in which the vehicle travels at a second speed higher than the first speed.

(3): In the aspect of (2) described above, when a second predetermined period has elapsed from a time at which a predetermined user or all users among the one or more users have got off the vehicle, when a vehicle has moved from a position at which a predetermined user or all users among the one or more users have got off to a predetermined position, or when a predetermined user or all users among the one or more users are not recognized by the vicinity situation recognizer, the driving controller determines that the predetermined condition has been satisfied.

(4): In the aspect of (3) described above, when a predetermined user or all users among the one or more users are in a predetermined state in the first predetermined period, the driving controller is configured to cause the vehicle to execute an action different from when not in the predetermined state.

(5): In the aspect of (4) described above, the predetermined state is a state (hereinafter, a first state) in which at least one user among the one or more users has performed a predetermined gesture, a state (hereinafter, a second state) in which at least one user among the one or more users falls to a ground and is in a prone state in a third predetermined period or more, or a state (hereinafter, a third state) in which at least one user among the one or more users is estimated to be damaged by a person or an object different from the one or more user.

(6): In the aspect of (5) described above, the driving controller, in the first state, is configured to cause the vehicle to continue traveling, cause the vehicle to further travel in a predetermined route, and cause the vehicle to return near a position at which the user is present.

(7): In the aspect of (5) or (6) described above, the predetermined gesture is a gesture indicating that the user has left something in the vehicle or a gesture calling back the vehicle.
(8): In the aspect of any one of (5) to (7) described above, a communicator configured to communicate with a predetermined terminal device is further included, in which the driving controller is configured transmit information on the predetermined state to the predetermined terminal device using the communicator when the user is in any predetermined state among the second state or the third state.
(9): In the aspect of any one of (2) to (8) described above, the driving controller is configured to cause an outputter that is configured to output information to output information on the predetermined state when the user is in any predetermined state among the second state or the third state.

(10): In the aspect of any one of (2) to (9) described above, the vicinity situation recognizer is configured to continue processing of monitoring the one or more users in the first predetermined period in the automated entrance processing.

(11): In the aspect of any one of (1) to (10) described above, the driving controller is configured to cause the vehicle to travel at the first speed in the first predetermined period, and cause the vehicle to travel at the second speed higher than the first speed after the first predetermined period has elapsed in automated entrance processing for causing the vehicle to enter the parking lot by the driving control after only a driver gets on the vehicle and the driver gets off the vehicle.

(12): A monitoring system according to another aspect includes the vehicle control device according to any one of the aspects from (1) to (11) described above, and a monitor configured to monitor an action of a user on the basis of an image captured by an imager that captures an image of the user who gets off the vehicle, in which, when the monitor recognizes that the user is in a predetermined state, the driving controller is configured to cause the vehicle to execute an action different from when not in the predetermined state.

(13): A vehicle control method according to still another aspect includes, by one or more control device, recognizing a vicinity situation of a vehicle, performing driving control on steering and acceleration or deceleration of the vehicle on the basis of the recognized vicinity situation, causing the vehicle to travel with a first behavior in a first predetermined period from a first timing at which the vehicle has started after the predetermined event to a second timing at which a predetermined condition is satisfied, and causing the vehicle to travel with a second behavior in which a proceeding distance per unit time is longer than the first behavior after the first predetermined period has elapsed in processing of the driving control after a predetermined event of the vehicle.

(14): A storage medium according to still another aspect includes stores a program causing one or more control devices to recognize a vicinity situation of a vehicle, to perform driving control on steering and acceleration or deceleration of the vehicle on the basis of the recognized vicinity situation, to cause the vehicle to travel with a first behavior in a first predetermined period from a first timing at which the vehicle has started after the predetermined event to a second timing at which a predetermined condition is satisfied, and to cause the vehicle to travel with a second behavior in which a proceeding distance per unit time is longer than the first behavior after the first predetermined period has elapsed in processing of the driving control after a predetermined event of the vehicle.

According to (1) to (5), and (11) to (14), it is possible to care for the user after a predetermined event (for example, getting off the vehicle).

According to (6) of (7), the vehicle control device can further improve the convenience of the user.

According to (8) or (9), the vehicle control device can further assist the rescue of the user.

According to (10), since the vehicle control device can further continue processing of monitoring in the first predetermined period, it is possible to care for the user while considering the processing load.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram which schematically shows a scene in which an autonomous parking event is executed.

FIG. 4 is a diagram which shows an example of a configuration of a parking lot management device.

FIG. 5 is a diagram showing an example of a behavior of a host vehicle after a user gets off the vehicle.

FIG. 6 is a diagram showing a relationship between an action of the user after getting off the vehicle and processing of the host vehicle M (particularly, recognition processing).

FIG. 7 is a diagram which shows an example of a state of a user and content of state information in an image.

FIG. 8 is a diagram showing a relationship between the action of the user after getting off the vehicle and the processing (particularly, recognition processing) of the host vehicle.

FIG. 9 is a diagram showing an example of a third action.

FIG. 10 is a diagram showing an example of a scene in which information on a predetermined state is transmitted.

FIG. 11 is a diagram showing an example of a scene in which predetermined information is output.

FIG. 12 is a diagram which shows an example of a functional configuration of a parking lot management system.

FIG. 13 is a sequence diagram which shows an example of a flow of processing executed by the parking lot management system.

FIG. 14 is a diagram which shows an example of an image displayed on a displayer of a terminal device.

FIG. 15 is a diagram which shows an example of a hardware configuration of an automated driving control device of the embodiment.

### DETAILED DESCRIPTION

Hereinafter, embodiments of a vehicle control device, a monitoring system, a vehicle control method, and a storage medium will be described with reference to the drawings.

### First Embodiment

[Overall Configuration]

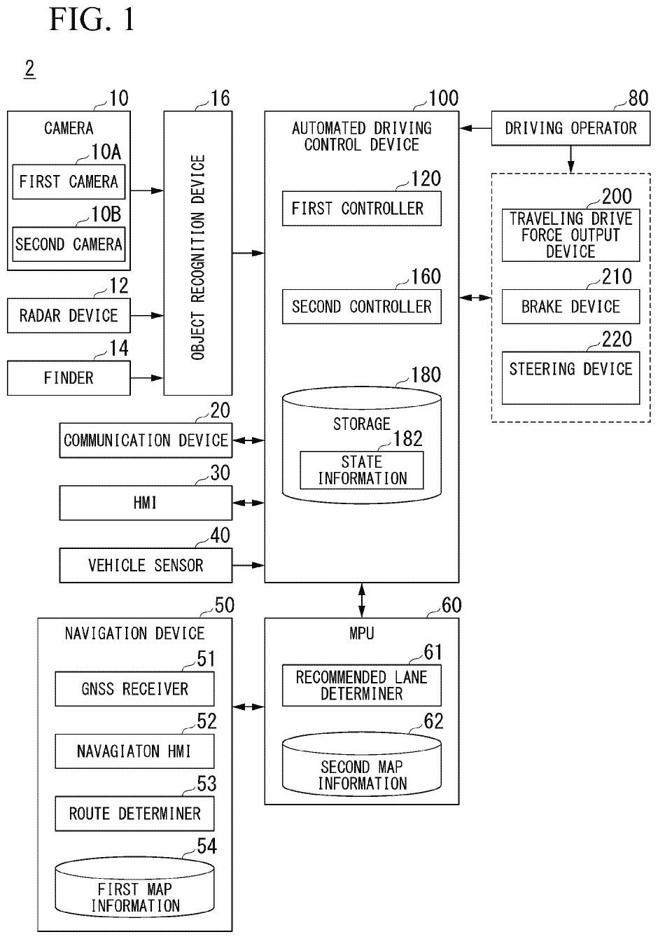

FIG. 1 is a configuration diagram of a vehicle system 2 using a vehicle control device according to an embodiment. A vehicle on which the vehicle system 2 is mounted is, for example, a two-wheel, three-wheel, or four-wheel vehicle, and a driving source thereof is an internal combustion engine such as a diesel engine or a gasoline engine, an electric motor, or a combination of these. The electric motor operates using electric power generated by a generator connected to the internal combustion engine, or discharge power of a secondary battery or a fuel cell.

The vehicle system 2 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The communication shown in FIG. 1 is merely an example, and some of the configuration may be omitted or another configuration may be further added.

The camera 10 includes, for example, a first camera 10A and a second camera 10B. The first camera 10A is, for example, a digital camera using a solid-state imaging sensor such as a charge coupled device (CCD) or a complementary metal oxide semiconductor (CMOS). The first camera 10A and the second camera 10B are attached to arbitrary places of a vehicle (hereinafter, a host vehicle M) on which the vehicle system 2 is mounted. For example, the camera 10 is attached to an upper part of the front windshield, a rear surface of the windshield rearview mirror, or the like and captures an image of the front of the vehicle. The camera 10 captures, for example, an image of a vicinity of the host vehicle M periodically and repeatedly. The camera 10 may also be a stereo camera. The second camera 10B has the same function as the first camera 10A. The second camera 10B is attached to, for example, an upper part of the rear windshield, near a license plate on a rear outside of a vehicle, or near trunk door on the rear outside of the vehicle, and captures an image of the rear of the vehicle. The camera 10 may include a camera for capturing images of sides of the vehicle in addition to the first camera 10A and the second camera 10B.

The radar device 12 emits radio waves such as millimeter waves to the vicinity of the host vehicle M and detects radio waves (reflected waves) reflected by an object to detect at least a position (distance and orientation) of the object. The radar device 12 is attached to an arbitrary place of the host vehicle M. The radar device 12 may detect a position and a speed of the object using a frequency modulated continuous wave (FM-CW) method.

The finder 14 is a light detection and ranging (LIDAR). The finder 14 emits light to the vicinity of the host vehicle M and measures scattered light. The finder 14 detects a distance to the object on the basis of time from light emission to light reception. The emitted light is, for example, a pulsed laser beam. The finder 14 is attached to an arbitrary place of the host vehicle M.

The object recognition device 16 performs sensor fusion processing on results of detection by some or all of the camera 10, the radar device 12, and the finder 14, and recognizes the position, type, speed, and the like of the object. The object recognition device 16 outputs a result of the recognition to the automated driving control device 100. The object recognition device 16 may output the results of detection by the camera 10, the radar device 12, and the finder 14 to the automated driving control device 100 as they are. The object recognition device 16 may also be omitted from the vehicle system 2.

The communication device 20 uses, for example, a cellular vehicle, a Wi-Fi network, a Bluetooth (registered trademark), a dedicated short range communication (DSRC), or the like, and communicates with another vehicle or a parking lot management device (to be described below) existing in the vicinity of the host vehicle M or various server devices.

The HMI 30 presents various types of information to a user of the host vehicle M and receives an input operation from the user. The HMI 30 includes various display devices, speakers, buzzers, touch panels, switches, keys, and the like.

The vehicle sensor 40 includes a vehicle speed sensor that detects the speed of the host vehicle M, an acceleration sensor that detects an acceleration, a yaw rate sensor that detects an angular speed around a vertical axis, an orientation sensor that detects a direction of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M on the basis of a signal received from a GNSS satellite. The position of the host vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the host vehicle M identified by the GNSS receiver 51 (or an arbitrary input position) to a destination input by the user using the navigation HMI 52 (hereinafter, a route on a map) with reference to the first map information 54. The first map information 54 is, for example, information in which a road shape is expressed by a link indicating a road and nodes connected by the link. The first map information 54 may include a curvature of a road, point of interest (POI) information, and the like. The route on a map is output to the MPU 60. The navigation device 50 may perform route guidance using the navigation HMI 52 on the basis of the route on a map. The navigation device 50 may be realized by, for example, a function of a terminal device such as a smartphone or a tablet terminal carried by the user. The navigation device 50 may transmit a current positon and a destination to a navigation server via the communication device 20, and acquire the same route as the route on a map from the navigation server.

The MPU 60 includes, for example, a recommended lane determiner 61, and holds second map information 62 in the storage device such as an HDD or a flash memory. The recommended lane determiner 61 divides the route on a map provided from the navigation device 50 into a plurality of blocks (for example, divides every 100 [m] in a vehicle proceeding direction), and determines a recommended lane for each block with reference to the second map information 62. The recommended lane determiner 61 determines which lane from the left to travel. When a branch place is present in the route on a map, the recommended lane determiner 61 determines a recommended lane such that the host vehicle M can travel a reasonable route for proceeding to the branch destination.

The second map information 62 is information with higher accuracy than the first map information 54. The second map information 62 includes, for example, information on a center of a lane, information on a boundary of a lane, or the like. The second map information 62 may include road information, traffic regulation information, address information (addresses and postal codes), facility information, telephone number information, and the like. The second map information 62 may be updated at any time by the communication device 20 communicating with another device.

The driving operator 80 includes, for example, accelerator pedals, brake pedals, shift levers, steering wheels, modified steering, joysticks, and other operators. A sensor that detects an amount of operation or a presence or absence of an operation is attached to the driving operator 80. A result of the detection is output to the automated driving control device 100, or some or all of the traveling drive force output device 200, the brake device 210, and the steering device 220.

The automated driving control device 100 includes, for example, a first controller 120, a second controller 160, and a storage 180. The first controller 120 and the second controller 160 are realized by, for example, a hardware processor such as a central processing unit (CPU) executing a program (software). Some or all of these components include hardware (circuit unit; circuitries) such as a large scale integration (LSI), an application specific integrated circuit (ASIC), a field-programmable gate array (FPGA), and a graphics processing unit (GPU), or may also be realized by cooperation of software and hardware. The program may be stored in advance in a storage device (storage device including a non-transitory storage medium) such as an HDD or a flash memory of the automated driving control device 100 in advance, or may be stored in a detachable storage medium such as a DVD or a CD-ROM and installed in the HDD or the flash memory of the automated driving control device 100 by the storage medium (non-transitory storage medium) being mounted on a drive device.

The storage 180 is realized by an HDD, a flash memory, an electrically erasable programmable read only memory (EEPROM), a random access memory (RAM), or the like. The storage 180 stores, for example, state information 182. Details of the state information 182 will be described below.

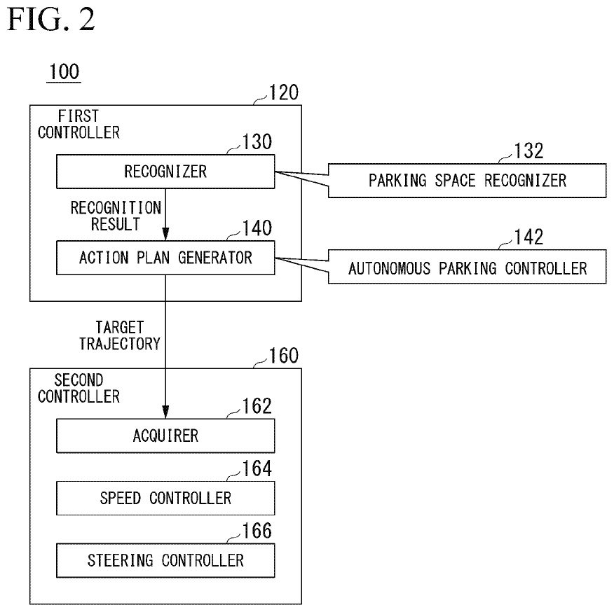

FIG. 2 is a functional configuration diagram of the first controller 120 and the second controller 160. The first controller 120 includes, for example, a recognizer 130 and an action plan generator 140 (an example of the “driving controller”). The first controller 120 realizes, for example, a function based on artificial intelligence (AI) and a function based on a model given in advance in parallel. For example, a function of “recognizing an intersection” may be executed in parallel with recognition of an intersection by deep learning and the like and recognition based on conditions given in advance (such as a signal that can be subjected to pattern matching, a road sign, and the like), and may be realized by scoring both recognition and comprehensively evaluating them. As a result, a reliability of automated driving is secured.

The recognizer 130 recognizes a state such as a position, a speed, an acceleration, and the like of an object in the vicinity of the host vehicle M on the basis of information input from the camera 10, the radar device 12, and the finder 14 via the object recognition device 16. The position of an object is recognized as a position on absolute coordinates with a representative point (a center of gravity, a center of a drive shaft, and the like) of the host vehicle M as an origin, and is used for control. The position of an object may be represented by a representative point such as the center of gravity or a corner of the object, or may be represented by a represented area. The “state” of the object may include an acceleration or jerk of the object, or an “action state” (for example, whether a lane change is being performed or is intended to be performed).

The recognizer 130 recognizes, for example, a lane (traveling lane) in which the host vehicle M is traveling. For example, the recognizer 130 recognizes the traveling lane by comparing a pattern of a road section line (for example, an array of solid lines and dashed lines) obtained from the second map information 62 with a pattern of a road section line in the vicinity of the host vehicle M recognized from an image captured by the camera 10. The recognizer 130 may recognize the traveling lane by recognizing not only a road section line but also a road boundary including the road section line, a road shoulder, a curb, a median strip, and a guardrail. In this recognition, the position of the host vehicle M acquired from the navigation device 50 and a result of processing by the INS may be added. The recognizer 130 recognizes stop lines, obstacles, red lights, toll booths, and other road events.

The recognizer 130 recognizes the position and posture of the host vehicle M with respect to the traveling lane when the traveling lane is recognized. The recognizer 130 may recognize a deviation of a reference point of the host vehicle M from the center of the lane and an angle formed against a line connecting the center of the lane in the proceeding direction of the host vehicle M as a relative position and posture of the host vehicle M. Instead, the recognizer 130 may recognize a position of the reference point of the host vehicle or the like with respect to any side end (a road section line or road boundary) of the traveling lane) as the relative position of the host vehicle M with respect to the traveling lane. The recognition processing as described above may be referred to as first recognition processing. Recognition processing different from described above may be referred to as “second recognition processing”. Details of the second recognition processing will be described below.

The recognizer 130 includes a parking space recognizer 132 that is activated in an autonomous parking event to be described below. Details of functions of the parking space recognizer 132 will be described below.

The action plan generator 140 travels in a recommended lane determined by the recommended lane determiner 61, in principle, and further generates a target trajectory in which the host vehicle M will automatically (independently from an operation of a driver) travel to be able to cope with a vicinity situation of the host vehicle M. The target trajectory includes, for example, a sped element. For example, the target trajectory is expressed as a sequential arrangement of trajectory points to be reached by the host vehicle M. The trajectory points are points to be reached by the host vehicle M every predetermined traveling distance (for example, about several [m]) on a road, and apart from this, a target speed and a target acceleration for each predetermined sampling time (for example, about 0 commas [sec]) are generated as a part of the target trajectory. The trajectory point, for each predetermined sampling time, may be a position to be reached by the host vehicle M at a corresponding predetermined sampling time. In this case, information on the target speed and the target acceleration is expressed by an interval of the trajectory points.

The action plan generator 140 may set an event of automated driving in generating the target trajectory. Examples of the event of automated driving includes a constant speed traveling event, a low-speed following traveling event, a lane change event, a branch event, a merging event, a takeover event, an autonomous parking event in which a vehicle parks with unmanned traveling or automated traveling in valet parking or the like, and the like. The action plan generator 140 generates a target trajectory in accordance with an activated event. The action plan generator 140 includes an autonomous parking controller 142 which is activated when the autonomous parking event is executed. Details of functions of the autonomous parking controller 142 will be described below.

The second controller 160 controls the traveling drive force output device 200, the brake device 210, and the steering device 220 such that the host vehicle M passes through a target trajectory generated by the action plan generator 140.

Returning to FIG. 2, the second controller 160 includes, for example, an acquirer 162, a speed controller 164, and a steering controller 166. The acquirer 162 acquires information on the target trajectory (trajectory point) generated by the action plan generator 140, and causes it to be stored in a memory (not shown). The speed controller 164 controls the traveling drive force output device 200 or the brake device 210 on the basis of a speed element associated with the target trajectory stored in the memory. The steering controller 166 controls the steering device 220 in accordance with a bending condition of the target trajectory stored in the memory. The processing performed by the speed controller 164 and the steering controller 166 are, for example, realized by a combination of feed forward control and feedback control. As an example, the steering controller 166 executes a combination of the feed forward control in accordance with a curvature of a road ahead of the host vehicle M and the feedback control based on a deviation from the target trajectory.

The traveling drive force output device 200 outputs a traveling drive force (torque) for traveling of the vehicle to drive wheels. The traveling drive force output device 200 includes, for example, a combination of an internal combustion engine, an electric motor, a transmission, and the like, and an electronic control unit (ECU) for controlling these. The ECU controls the constituents described above according to information input from the second controller 160 or information input from the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls an electric motor according to the information input from the second controller 160 and the information input from the driving operator 80, and outputs a brake torque in accordance with a braking operation to each vehicle wheel. The brake device 210 may include, as a backup, a mechanism that transmits a hydraulic pressure generated by an operation of a brake pedal included in the driving operator 80 to the cylinder via a master cylinder. The brake device 210 is not limited to the configuration described above, and may be electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes, for example, a direction of steering wheels by, for example, applying a force to a rack and pinion mechanism. The steering ECU drivers the electric motor according to the information input from the second controller 160 or the information input from the driving operator 80 and changes a direction of the steering wheels.

[Autonomous Parking Event-at the Time of Entrance]

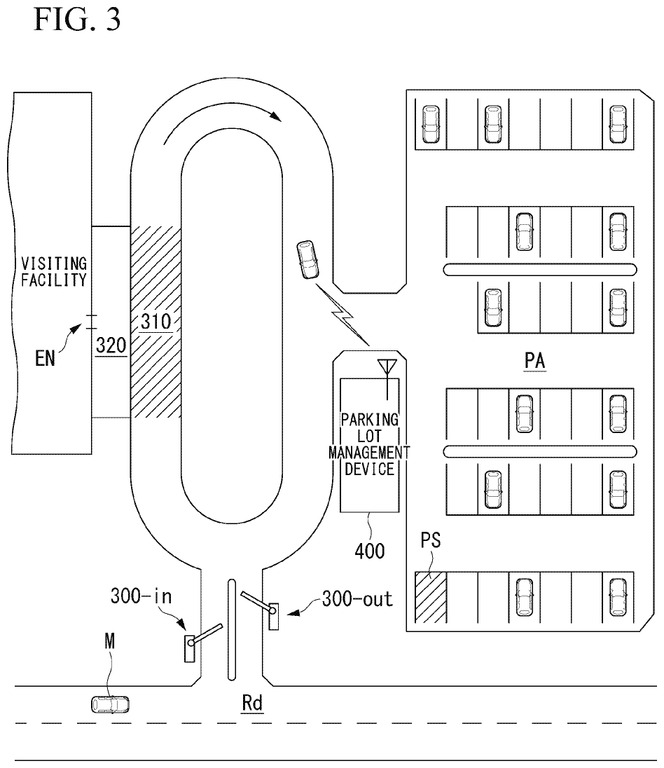

The autonomous parking controller 142 causes, for example, the host vehicle M to park in a parking space on the basis of the information acquired from the parking lot management device 400 by the communication device 20. FIG. 3 is a diagram which schematically shows a scene in which the autonomous parking event is executed. In a route from a road RD to a destination facility, gates 300-in and 300-out are provided. The host vehicle M passes through the gate 300-in and proceeds to the stop area 310 by manual driving or automated driving. The stop area 310 faces a getting-on/off area 320 connected to a visiting facility. The getting-on/off area 320 is provided with an eave to avoid rain and snow.

The host vehicle M performs automated driving in an unmanned state after lowering the user in the stop area 310, and starts an autonomous parking event that moves to a parking space PS in a parking lot PA. A start trigger of the autonomous parking event may be, for example, any operation by the user, or may be a reception of a predetermined signal wirelessly from the parking lot management device 400. The autonomous parking controller 142 transmits a parking request to the parking lot management device 400 by controlling the communication device 20. Then, the host vehicle M moves from the stop area 310 to the parking lot PA according to a guidance of the parking lot management device 400 or while sensing by itself.

When the user who gets off the host vehicle M performs a predetermined gesture, the host vehicle M may recognize that a parking request has been made and start moving. In this case, the recognizer 130 recognizes that the parking request has been made when it recognizes that the user has performed a gesture associated with the parking request which is set in advance on the basis of a result of the analysis of the image captured by the camera 10. In addition to the gesture associated with the parking request, information indicating other types of gestures may also be stored in the automated driving control device 100. The information indicating a gesture is information based on the result of analyzing an image in which a state in which a user performs a gesture is captured. The information based on the result of the analysis is information indicating a distribution of a feature amount such as a luminance value. The other types include, for example, a gesture for instructing a pick-up, a gesture for instructing to travel backward, a gesture for instructing to open or close a door or a trunk, a gesture for instructing to return to the getting-on/off area 320, a gesture indicating an intention to take out something left in the vehicle compartment, and the like.

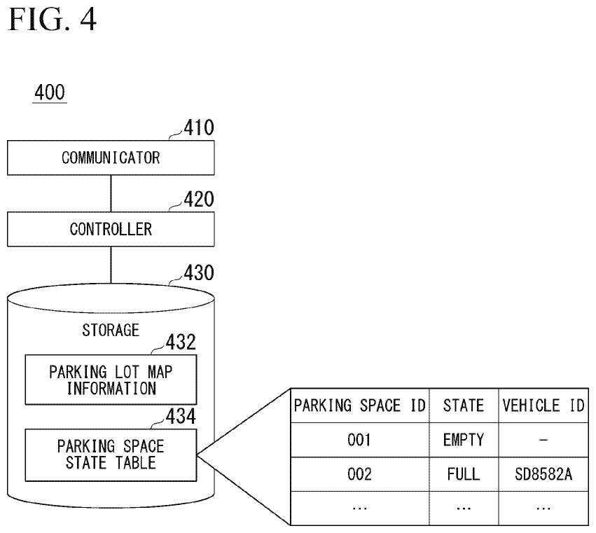

FIG. 4 is a diagram which shows an example of the configuration of the parking lot management device 400. The parking lot management device 400 includes, for example, a communicator 410, a controller 420, and a storage 430. The storage 430 stores information such as parking lot map information 432 and a parking space state table 434.

The communicator 410 wirelessly communicates with the host vehicle M and other vehicles. The controller 420 guides a vehicle to a parking space PS on the basis of information acquired by the communicator 410 and information stored in the storage 430. The parking lot map information 432 is information that geometrically represents a structure of a parking lot PA. The parking lot map information 432 includes coordinates for each parking space PS.

The parking space state table 434 includes, for example, a state indicating whether a parking space is in an empty state or a full state (parking) and a vehicle ID that is identification information of a parking vehicle in the full state are associated with a parking space ID that is identification information of a parking space PS.

If the communicator 410 receives a parking request from a vehicle, the controller 420 extracts a parking space PS whose state is an empty state with reference to the parking space state table 434, acquires a position of the extracted parking space PS from the parking lot map information 432, and transmits a suitable route to the acquired position of the parking space PS to the vehicle using the communicator 410. The controller 420 instructs an identified vehicle to stop, slow down, or the like when necessary on the basis of a positional relationship of a plurality of vehicles such that the vehicles do not proceed to the same place at the same time.

In a vehicle which has received a route (hereinafter, referred to as the host vehicle M), the autonomous parking controller 142 generates a target trajectory based on the route. If a target parking space PS is approached, the parking space recognizer 132 recognizes a parking frame line and the like that partition the parking space PS, and recognizes a detailed position of the parking space PS to provide it to the autonomous parking controller 142. The autonomous parking controller 142 corrects the target trajectory by receiving it, and causes the host vehicle M to park in the parking space PS.

[Autonomous Parking Event-at the Time of Exit]

The autonomous parking controller 142 and the communication device 20 maintain an operation state even when the host vehicle M is parked. The autonomous parking controller 142 causes a system of the host vehicle M to be activated and causes the host vehicle M to move to the stop area 310 when, for example, the communication device 20 has received a pick-up request from a terminal device of the user. At this time, the autonomous parking controller 142 controls the communication device 20 and transmits a start request to the parking lot management device 400. The controller 420 of the parking lot management device 400, like at the time of entrance, instructs an identified vehicle to stop, slow down, or the like when necessary on the basis of the positional relationship of a plurality of vehicles such that the vehicles do not proceed to the same place at the same time. If the host vehicle M is moved to the stop area 310 and causes the user to get thereon, the autonomous parking controller 142 stops operating, and thereafter, manual driving or automated driving by another functional unit is started.

Not limited to the description described above, the autonomous parking controller 142, independently from communication, may find an empty parking space by itself on the basis of a result of detection by the camera 10, the radar device 12, the finder 14, or the object recognition device 16, and cause the host vehicle M to park in the found parking space.

[Behavior of Host Vehicle after Getting Off (Part 1)]

Hereinafter, the host vehicle M after the user gets off the host vehicle M will be described. In automated entrance processing for causing the host vehicle M to enter the parking lot PA with driving control after one or more users of the host vehicle M get off the vehicle on the basis of a vicinity situation recognized by the recognizer 130, the automated driving control device 100 causes the host vehicle M to travel with a first behavior in the first predetermined period from a first timing at which the host vehicle has started after one or more users get off the vehicle to a second timing at which a predetermined condition is satisfied, and causes the host vehicle M to travel with a second behavior in which the proceeding distance per unit time is longer than with the first behavior after the first predetermined period has elapsed. The first behavior is a behavior in which the vehicle travels at a first speed, and the second behavior is a behavior in which the vehicle travels at a second speed higher than the first speed. The “first speed” is a speed lower than the second speed. The “second speed” is a limit speed in the parking lot PA. The first speed may vary with time as long as it is less than the second speed. The second speed may vary with time as long as it is equal to or less than the limit speed. The “traveling at the first speed” may mean that the host vehicle M accelerates up to a speed less than the second speed from a stopped state and travels at a constant speed, or the host vehicle M may accelerate up to the first speed from the stopped state in the predetermined period. In any case, after the predetermined period has elapsed, the host vehicle M accelerates up to the second speed.

The “predetermined condition” is that any one of the following conditions (1) to (3) is satisfied.

(1) A second predetermined period has elapsed from a time at which a predetermined user or all users among one or more users get off the host vehicle M. The “second predetermined period” is for example, time (for example, about 3 to 30 seconds) that the host vehicle M proceeds a predetermined distance (10 to 50 m) at the first speed. The “predetermined user” is any user, such as a user who first gets off or a user who has been seated in a predetermined seat.

(2) A predetermined user or all users among one or more users have moved from the getting-on/off area 320 (an example of a getting-off position) to a predetermined position. The “predetermined position” is, for example, a position which is a predetermined distance (for example, about 5 to 20 m) away from the getting-on/off area 320, or a position at or near an entrance of a facility related to the parking lot PA. The “predetermined user” is, for example, any user such as a user who has reached the entrance last or a user who has been seated in a predetermined seat.

(3) A predetermined user or all users among one or more users are not recognized by the recognizer 130. The fact that it is not recognized by the recognizer 130 means that the user is outside the image-capturing area of the second camera 10B or that an image of the user is captured by the second camera 10B but the recognizer 130 cannot recognize the user even if it recognizes the captured image described above. The “predetermined user” is, for example, any user such as a user who has been seated in a predetermined seat.

In automated entrance processing for causing the vehicle to enter a parking lot under control after only a predetermined user (for example, a driver) gets on the host vehicle M and the predetermined user (for example, the driver) gets off the vehicle, the automated driving control device 100 may cause the host vehicle M to travel at the first speed in the first predetermined period and cause the host vehicle M to travel at the second speed higher than the first speed after the first predetermined period has elapsed, or cause the host vehicle M to execute each piece of processing to be described below.

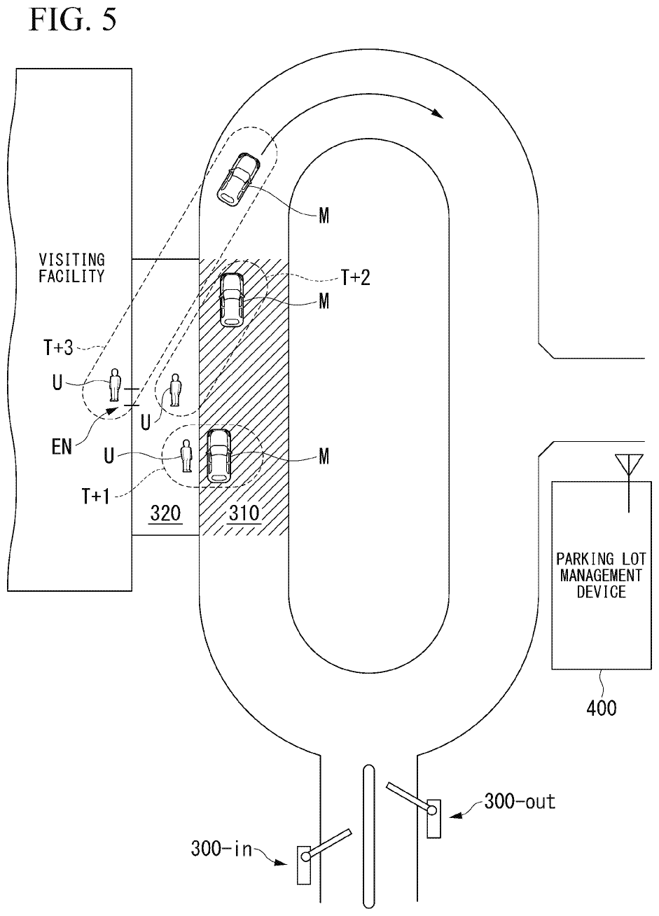

FIG. 5 is a diagram showing an example of a behavior of the host vehicle M after getting off. FIG. 5 is a diagram in which a part (the parking lot PA or the road Rd) of FIG. 3 is omitted. Description which is the same as in FIG. 3 will be omitted. In the following description, it is assumed that a predetermined condition is satisfied when the user has reached the entrance of the facility related to the parking lot PA of above-described (2).

At a time T+1, if a user U transmits a parking request to the host vehicle M after a user gets off the host vehicle M, the host vehicle M starts moving toward the parking lot PA. The starting timing is an example of the “first timing.”

At time T+2, the user proceeds to the entrance EN of the facility and travels toward the parking lot PA. At this time, the host vehicle M performs a first action and heads for the parking lot PA. The first action is an action in which the vehicle travels at the first speed and heads for the parking lot PA.

At a time T+3, if the user reaches the entrance EN of the facility, the automated driving control device 100 recognizes that the user has reached the entrance EN of the facility. The automated driving control device 100 stops the first action and performs a second action according to the recognition described above. The second action is that the host vehicle M travels at a second speed higher than the first speed. A timing at which the automated driving control device 100 recognizes that the user has reached the entrance EN of the facility is an example of the “second timing.”

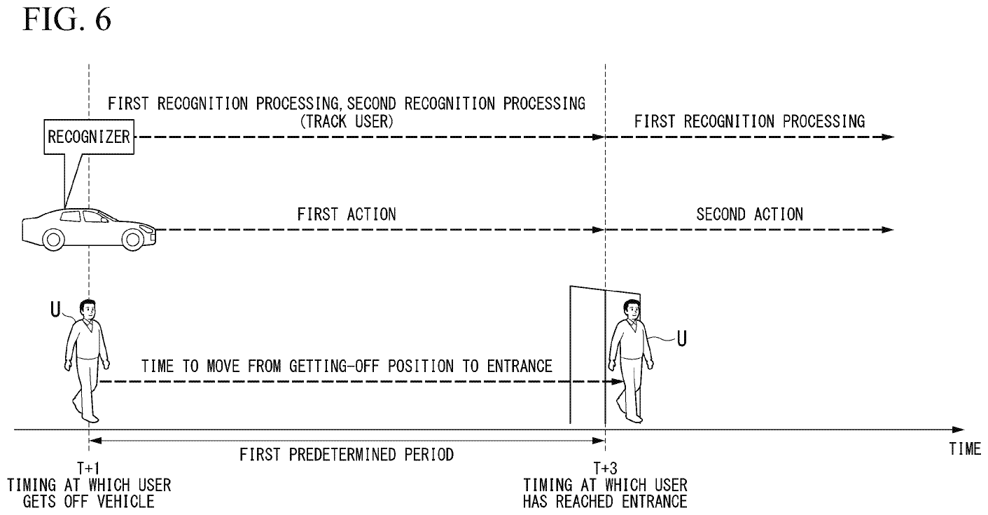

FIG. 6 is a diagram showing a relationship between the action of the user after getting off the vehicle and the processing of the host vehicle M (in particular, recognition processing). A horizontal axis in FIG. 6 represents time. Content different from the content described in FIG. 5 will be described. Between the time T+1 and the time T+3 (the first predetermined period), the recognizer 130 performs first recognition processing and second recognition processing. After the time T+3 has elapsed, the recognizer 130 stops the second recognition processing and continues the first recognition processing.

The second recognition processing is processing for recognizing a user who gets off the vehicle in an image and tracking (monitoring) the recognized user. By this processing, the recognizer 130 can continue to recognize the user in the first predetermined period. The first recognition processing is processing for recognizing a vicinity of the host vehicle M in automated driving. The first recognition processing is, like the second recognition processing, processing for distinguishing the user getting off the vehicle from other users or recognizing the vicinity of the host vehicle M without paying attention to the user getting off the vehicle.

As described above, the automated driving control device 100 can care for the user after getting off the vehicle by causing the host vehicle M to perform the first action in the first predetermined period and causing the host vehicle M to perform the second action after the first predetermined period has elapsed. This is because the host vehicle M can observe the action of the user in the first predetermined period and when the user is in a predetermined state as described in [behavior of the host vehicle M after getting off (part 2)], it can perform an action in accordance with the predetermined state.

[Behavior of the Host Vehicle after Getting Off (Part 2)]

When a predetermined user or all users among one or more users are in a predetermined state in the first predetermined period from a first timing at which the host vehicle M has started after one or more users get off the vehicle to a second timing at which a predetermined condition is satisfied, the automated driving control device 100 causes the host vehicle to execute an action different from when not in the predetermined state.

The predetermined state is one or more of the following states from (a first state) to (a third state). (The first state) A state in which at least one user among one or more users has performed a predetermined gesture. (The second state) A state in which at least one user among the one or more users falls to the ground, and is in the prone state in the third predetermined period or longer. (The third state) A state in which at least one user among the one or more users is estimated to be damaged by a person or an object different from the one or more users. In the following description, the “predetermined state” and the “different action (a third action to a fifth action)” will be sequentially described in detail.

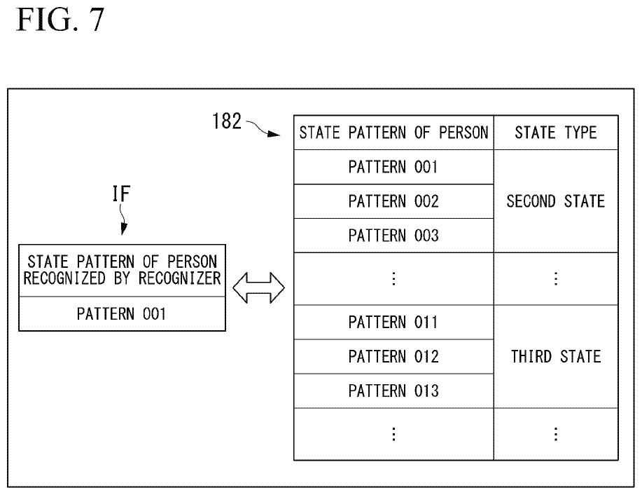

For example, the recognizer 130 recognizes the second state or the third state as follows. The recognizer 130 recognizes that the user is in the second state or the third state on the basis of the state information 182 and the state of the user in the image captured by the camera 10. FIG. 7 is a diagram which shows an example of the state of the user in the image and content of the state information 182. The state information 182 is, for example, information in which a state type (the second state or the third state) is associated with a state pattern of a person. The state pattern of a person is, for example, information based on a result of analysis of images in which persons having various states are captured, and is information indicating a distribution of a feature amount such as a luminance value. The various states include a state in which a person is in the prone state or a state in which a person is harmed by another person, and the like.

The recognizer 130 determines whether the state pattern (for example, the distribution of a feature amount) IF of the user obtained from the image captured by the camera 10 matches the state pattern of a person included in the state information 182. Matching is not limited to complete matching, and includes matching to more than a predetermined degree. In the determination described above, when it is determined that they match, the recognizer 130 recognizes that the user is in a state associated with a state pattern of the state information 182 determined to match. In the recognition processing described above, the recognizer 130 may recognize the state of the user in addition to a facial expression of the user. In this case, the state information 182 includes the facial expression pattern of a person for each state type. When it is determined that the number of times the state patterns match is continuously equal to or greater than a threshold, the recognizer 130 may recognize that the user is in a state associated with a state determined to match.

(Behavior when the First State has Occurred)

The predetermined gesture in the first state is a gesture indicating that the user has left something in the host vehicle or a gesture calling back the host vehicle. In the first state, the automated driving control device 100 causes the host vehicle M to continue traveling, causes the host vehicle to run in a predetermined route, and causes the host vehicle M to return to near a position in which the user is present. That is, the host vehicle M performs a third action. The position to which the host vehicle M returns may be a position near a position at which the user gets off the host vehicle M instead of near the position in which the user is present, and may be other predetermined positions.

The third action may be an action of traveling backward and returning to near the position in which the user is present or the stop area 310. For example, when the host vehicle M is present within a predetermined distance (for example, several meters) from the stop area, the action of traveling backward may be performed.

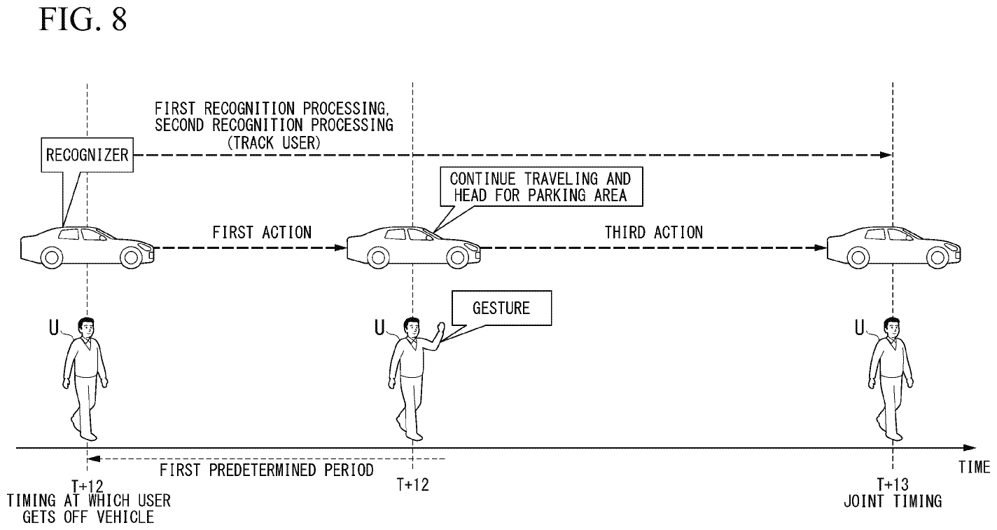

FIG. 8 is a diagram showing a relationship between the action of the user after getting off the vehicle and the processing (particularly, recognition processing) of the host vehicle M. A time T+11 is a timing at which the user gets off the host vehicle M. At a time T+12, when the user performs a gesture indicating that the user has left something, the host vehicle M stops the first action and starts the third action. The time T+12 is a time included in the first predetermined period in which the user is heading for the entrance of the facility. At a time T+13, the host vehicle M joins the user. Then, the user can take out something left from the vehicle compartment of the host vehicle M. The recognizer 130 performs, for example, first recognition processing and second recognition processing between the time T+11 and the time T+13.

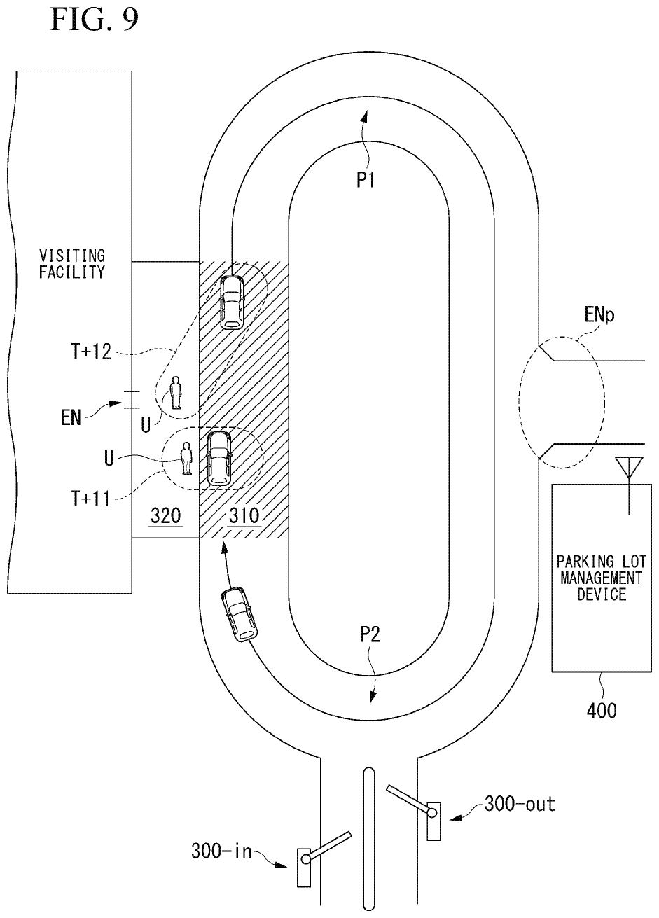

FIG. 9 is a diagram showing an example of the third action. At the time T+12, if the user U performs a predetermined gesture, the host vehicle M passes through an entrance ENp of the parking lot PA and performs the third action of returning to the stop area 310. Then, the host vehicle M joins the user.

The second recognition processing may be stopped in a predetermined period from the time T+12 and restarted after the predetermined period has elapsed. A timing at which the second recognition processing stops may be a time point at which the user is not recognized in the recognition processing, a time at which the host vehicle M has reached a point (for example, near P1 of FIG. 8) a predetermined distance ahead of the stop area 310, or the like. A timing at which the second recognition processing is restarted may be a timing at which the getting-on/off area 320 (or the stop area 310) is recognized or a timing at which the vehicle has reached a position a predetermined distance away from the stop area 310 (for example, near P2 of FIG. 8).

As described above, the automated driving control device 100 performs a third action when the user is in the first state in the first predetermined period, thereby improving the convenience of the user.

(Behavior when the Second State or the Third State has Occurred (Part 1))

The automated driving control device 100 transmits information on the predetermined state to a predetermined terminal device using the communication device 20 when the predetermined state is any one of the second state and the third state. That is, the host vehicle M performs a fourth action. The “predetermined terminal device” is a terminal device set in advance. The terminal device set in advance is a terminal device installed in a facility for rescuing a user or helping a user, a terminal device owned by a person close to the user, the parking lot management device 400, and the like.

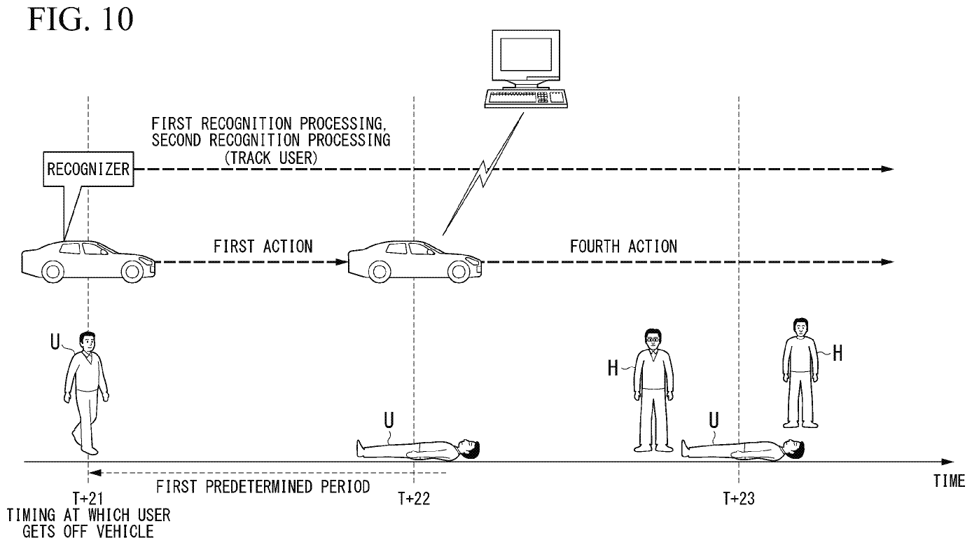

FIG. 10 is a diagram showing an example of a scene in which the information on the predetermined state is transmitted. In the example of FIG. 10, an example in which the second state has occurred will be described. A time T+21 is a timing when the user gets off the host vehicle M. At a time T+22, if the user falls to the ground and is in the prone state in the third predetermined period or more, the host vehicle M stops the first action and starts the fourth action. The time T+22 is a time included in the first predetermined period in which the user is heading for the entrance of the facility. At a time T+23, a rescuer H rescues the user according to the fourth action.

The recognizer 130 may perform the first recognition processing and the second recognition processing between the time T+21 and the time T+23, and stop the second recognition after the information on the predetermined state is transmitted to the predetermined terminal device by performing the fourth action.

The automated driving control device 100 may transmit the information on the predetermined state and position information of the user to the predetermined terminal device. In this case, the recognizer 130 refers to information in which an imaging direction of the camera 10, a size of an area in an image, a position of a target with respect to the position of the host vehicle M, which are stored in the storage device in advance, are associated with each other, and recognizes the position of the user who is a target with respect to the host vehicle M on the basis of the imaging direction of the camera 10, the size of an area associated with the user in an image captured by the camera 10, and the position of the area in the image. Then, the automated driving control device 100 identifies the position of the user on a map on the basis of the position of the host vehicle M and the recognized position of the user with respect to the host vehicle M as described above.

As described above, the automated driving control device 100 can assist a rescue of the user in the second state by performing the fourth action when the user is in the second state in the first predetermined period.

(Processing when the Second State or the Third State has Occurred (Part 2))

The automated driving control device 100 causes an outputter that outputs information to output the information on the predetermined state (predetermined information) when the user is in any predetermined state among the second state or the third state. That is, the host vehicle M performs a fifth action.

The “outputter that outputs information” is, for example, a speaker, a displayer, lights, lamps, wipers, a horn, and the like provided in the host vehicle M, which can output information that can cause to recognize that an abnormality has occurred in a person present in the vicinity of the host vehicle M or the user. The “outputter that outputs information” may be an outputter which is not provided in the host vehicle M as long as the outputter can be controlled by the host vehicle M performing communication. For example, the “outputter that outputs information” may be an outputter provided in the facility having the parking lot PA.

The “predetermined information” is, for example, information for requesting a rescue of a user or information indicating a possibility that an abnormality has occurred in a user. For example, the automated driving control device 100 causes the speaker to output the predetermined information, causes lights (for example, headlights) to blink, or sounds a horn when the user is in the predetermined state. For example, the automated driving control device 100 causes the wiper to operate even if it is not raining or causes a screen of the displayer provided in the vehicle to blink when the user is in the predetermined state. When the displayer is provided outside of the host vehicle M, the automated driving control device 100 may cause this displayer to output the predetermined information.

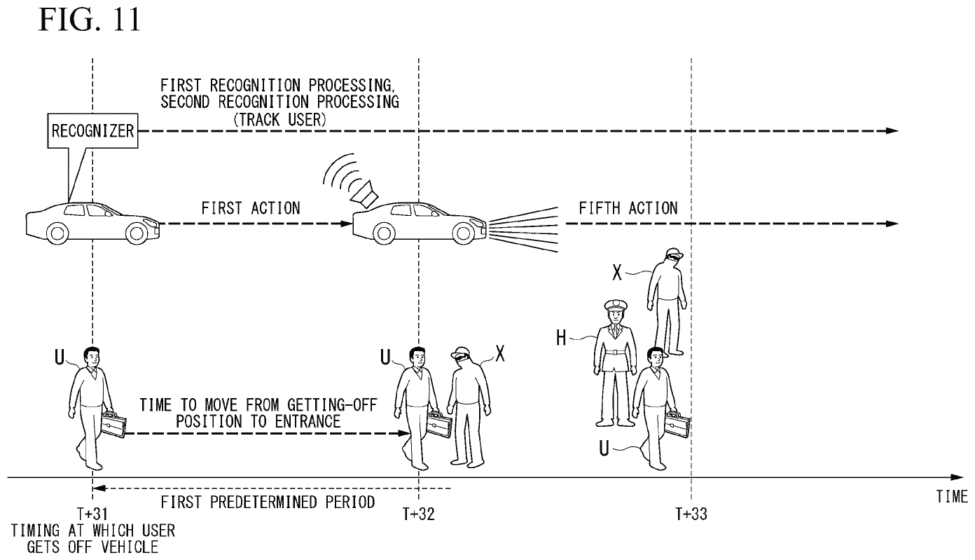

FIG. 11 is a diagram showing an example of a scene in which the predetermined information is output. In the example of FIG. 11, an example in which the third state has occurred will be described. A time T+31 is a timing at which the user U gets off the host vehicle M. At a timing T+32, when the user U is in the state in which the user is estimated to be damaged by a person X different from the user, the host vehicle M stops the first action and starts the fifth action. The time T+32 is a time included in the first predetermined period in which the user is heading for the entrance of the facility. At a time T+33, the rescuer rescues the user according to the fifth action.

The recognizer 130 may, for example, perform the first recognition processing and the second recognition processing between the time T+31 and the time T+33, and stop the second recognition processing after the third state is released by performing the fifth action.

As described above, the automated driving control device 100 can assist the rescue of the user who is in the third state by performing the fifth action when the user is in the third state in the first predetermined period.

According to the first embodiment described above, the automated driving control device 100 can care for the user after getting off the vehicle by causing the host vehicle M to travel at the first speed in the first predetermined period, and causing the host vehicle M to travel at the second speed higher than the first speed after the first predetermined period has elapsed. When the user is in the predetermined state in the first predetermined period, the automated driving control device 100 causes the host vehicle M to execute an action (any one of the third action to the fifth action) different from when the user is not in the predetermined state, thereby improving the convenience of the user or assisting the rescue of the user.

### Second Embodiment

Hereinafter, a second embodiment will be described. In the second embodiment, a parking lot management device 400A tracks the user who gets off the vehicle. Hereinafter, a difference from the first embodiment will be mainly described. In the following description, a difference from the second embodiment will be mainly described.

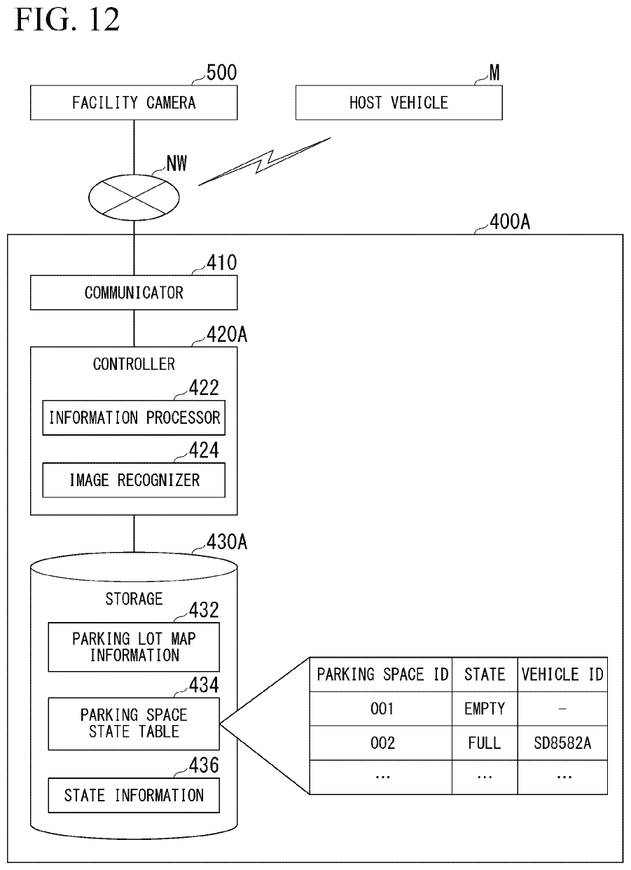

FIG. 12 is a diagram which shows an example of a functional configuration of the parking lot management system (monitoring system) 1. The parking lot management system 1 includes, for example, a plurality of vehicles including the host vehicle M, the parking lot management device 400A, and a facility camera 500. These communicate with each other via a network NW. The network NW includes the Internet, a wide area network (WAN), a local area network (LAN), a public line, a provider device, a dedicated line, a wireless base station, and the like.

The parking lot management device 400A includes a controller 420A instead of the controller 420, and a storage 430A instead of the storage 430. The controller 420A includes, for example, an information processor 422 and a recognizer 424. The recognizer 424 is an example of the “monitor.” The information processor 422 stores, for example, an image captured by the facility camera 500 in the storage 430A or processes the information transmitted from the host vehicle M. The recognizer 424 has the same function as the recognizer 130 of the first embodiment. For example, the recognizer 130 has a function of recognizing a state of the user who gets off the vehicle. The recognizer 424 monitors an action of the user on the basis of an image captured by the facility camera 500 that captures an image of the user who gets off the host vehicle M. The storage 430A stores the state information 436, information on a predetermined gesture, or an image captured by the facility camera 500 associated with an imaging time.

The facility camera 500 captures an image of an image-capturing area at predetermined intervals, and transmits the captured image to the parking lot management device 400A using a communication interface thereof. The image-capturing area of the facility camera 500 is, for example, a getting-on/off area 320, a route from the getting-on/off area 320 to the entrance of the facility, or the like.

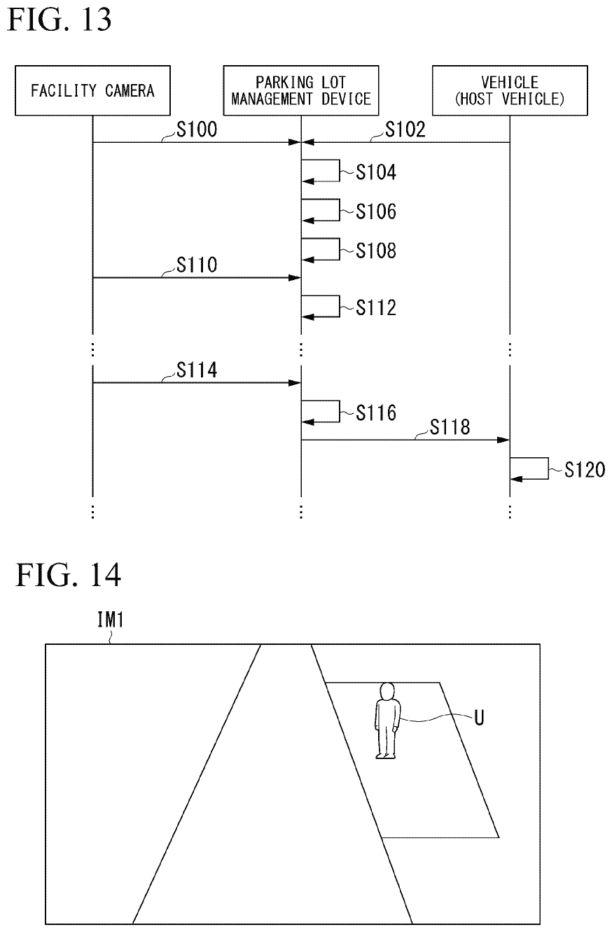

FIG. 13 is a sequence diagram which shows an example of a flow of processing executed by the parking lot management system 1. First, the facility camera 500 transmits the captured image to the parking lot management device 400 (step S100). Next, the automated driving control device 100 of the host vehicle M transmits getting-off information indicating the user gets off the vehicle to the parking lot management device 400A at a timing at which the user gets off the vehicle (step S102). For example, the host vehicle M recognizes the user getting off the vehicle on the basis of an analysis result of an image captured by the camera 10, an analysis result of an image captured by a camera provided in a vehicle compartment, a result of detection by a door sensor for detecting an open or closed state of a door, and the like.

Next, the information processor 422 of the parking lot management device 400 acquires the getting-off information transmitted in step S102 (step S104). Then, the information processor 422, on the basis of the acquired time of getting-off the vehicle, extracts an image captured by the facility camera 500 at the time of getting-off (step S104). Next, the recognizer 424 analyzes the image extracted in step S104 and identifies the user who gets off the vehicle (step S106).

Next, the information processor 422 acquires the image captured by the facility camera 500 (step S110). Next, the recognizer 424 tracks the user in the acquired image (step S112). This tracking is continued, for example, until the user reaches the entrance EN of the facility.

Next, the information processor 422 acquires the image captured by the facility camera 500 (step S114). Next, the recognizer 424 analyzes the image acquired in step S114 and recognizes that the user has entered the facility (step S116). Next, the information processor 422 transmits a result of the recognition in step S116 to the host vehicle M (step S118). The automated driving control device 100 of the host vehicle M performs an action different from the first action if the result of the recognition transmitted in step S108 is acquired (step S120). For example, the host vehicle M shifts from a state in which the vehicle is traveling at the first speed to a state in which the host vehicle M is traveling at the second speed.

When the recognizer 424 has recognized that the user is in a predetermined state when the user is tracked, the information processor 422 transmits information indicating the predetermined state to the host vehicle M. In this case, information indicating in which state among the first state to the third state the user may be transmitted. The host vehicle M performs an action in accordance with the state of the user.

In the second embodiment, the automated driving control device 100 may perform an action in accordance with the predetermined state (any one action between the third action and the fifth action) when the user has acquired information indicating the user is in the predetermined state before the host vehicle M enters the parking lot PA or before the vehicle park at a parking space.

According to the second embodiment described above, the same effect as in the first embodiment can be achieved, and a processing load of the host vehicle M is reduced.

In each of the embodiments described above, in the predetermined period or until the host vehicle M parks in the parking lot PA, the host vehicle M may transmit the image captured by the camera 10 of the host vehicle M to a terminal device carried by the user who gets off the vehicle. FIG. 14 is a diagram which shows an example of an image IM displayed on a displayer of the terminal device. For example, the image IM1 captured by the camera 10B is displayed on the displayer. For example, when the host vehicle automatically travels toward the parking lot PA, the user may continue to look at the host vehicle M in some cases. As described above, if the image is displayed on the displayer, a degree of security of the user is improved.

The automated driving control device 100, in processing of unmanned driving or automated driving after a predetermined event of the vehicle, may cause the vehicle to travel with a first behavior in a first predetermined period from a first timing at which the vehicle has started to a second timing at which a predetermined condition is satisfied after the predetermined event as described in the embodiment described above, and cause the vehicle to travel with a second behavior in which a proceeding distance of the vehicle per unit time is longer than with the first behavior after the first predetermined period has elapsed. The predetermined event may be an event in which one or more users of the vehicle get off the vehicle as described above, and may be another event related to the vehicle. The another event is an event in which luggage is taken out of a vehicle that carries luggage by unmanned driving or automated driving, an event in which luggage is unloaded, an event in which luggage is loaded, or the like. By the processing described above, the automated driving control device 100 can care for the user. For example, when the another event is executed, the vehicle travels with the first behavior when traveling to a predetermined position, and travels with the second behavior after the first predetermined period has elapsed.

[Hardware Configuration]

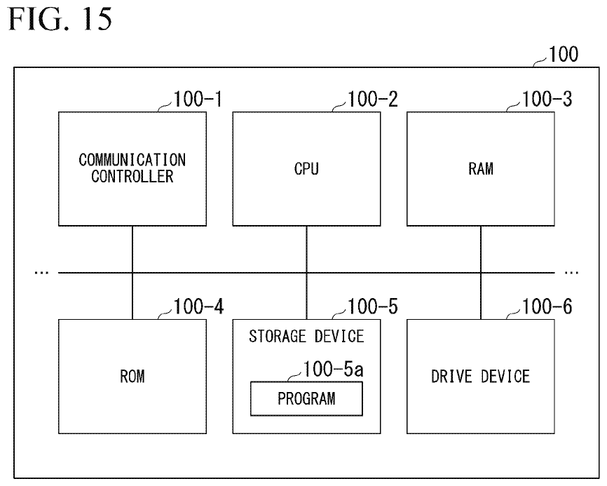

FIG. 15 is a diagram which shows an example of a hardware configuration of the automated driving control device 100 of the embodiment. As shown in FIG. 21, the automated driving control device 100 is configured to include a communication controller 100-1, a CPU 100-2, a random access memory (RAM) 100-3 used as a working memory, a read only memory (ROM) 100-4 that stores a booting program and the like, a storage device 100-5 such as a flash memory or a hard disk drive, a drive device 100-6, and the like connected to one another by an internal bus or a dedicated communication line. The communication controller 100-1 communicates with components other than the automated driving control device 100. The storage device 100-5 stores a program 100-5a executed by the CPU 100-2. This program is developed in the RAM 100-3 by a direction memory access (DMA) controller (not shown) or the like, and is executed by the CPU 100-2. Accordingly, some or all of the recognizer 130, the action plan generator 140, and the second controller are realized. The parking lot management device 400, similarly to the above description, is configured to include a communication controller, a CPU, a RAM, a ROM, a storage device, a drive device, and the like connected to each other by an internal bus or a dedicated communication line. Then, the program stored in the storage device is executed by the CPU, and thereby the controller 400 performs various processing.

The embodiments described above can be expressed as follows.

A vehicle control device includes a storage device that stores a program, and a hardware processor, the hardware processor executes the program stored in the storage device, thereby recognizing a vicinity situation of a vehicle, controlling steering and acceleration or deceleration of the vehicle on the basis of the recognized vicinity situation, causing the vehicle to travel with a first behavior in a first predetermined period from a first timing at which the vehicle has started to a second timing at which a predetermined condition is satisfied, and causing the vehicle to travel with a second behavior in which a proceeding distance per unit time is longer than with the first behavior after the first predetermined period has elapsed in processing of the control after a predetermined event of the vehicle.

As described above, modes for implementing the present invention have been described using the embodiments, but the present invention is not limited to these embodiments, and various modification and replacement can be made within a range not departing from the gist of the present invention.

What is claimed is:

1. A vehicle control device comprising:
a vicinity situation recognizer configured to recognize a vicinity situation of a vehicle; and
a driving controller configured to perform driving control on steering and acceleration or deceleration of the vehicle on the basis of the vicinity situation recognized by the vicinity situation recognizer,
wherein, in processing of the driving control after a predetermined event of the vehicle, the driving controller is configured to cause the vehicle to travel with a first behavior in a first predetermined period from a first timing at which the vehicle has started after the predetermined event to a second timing at which a predetermined condition is satisfied, and cause the vehicle to travel with a second behavior in which a proceeding distance of the vehicle per unit time is longer than with the first behavior after the first predetermined period has elapsed.

2. The vehicle control device according to claim 1,
wherein the predetermined event is an event in which one or more users of the vehicle get off the vehicle,
the driving controller is configured to cause the vehicle to travel with the first behavior in the first predetermined period and cause the vehicle to travel with the second behavior after the first predetermined period has elapsed in automated entrance processing for causing the vehicle to enter a parking lot with the driving control after the predetermined event,
the first behavior is a behavior in which the vehicle travels at a first speed, and the second behavior is a behavior in which the vehicle travels at a second speed higher than the first speed.

3. The vehicle control device according to claim 2,
wherein, when a second predetermined period has elapsed from a time at which a predetermined user or all users among the one or more users have got off the vehicle,
when a vehicle has moved from a position at which a predetermined user or all users among the one or more users have got off to a predetermined position, or
when a predetermined user or all users among the one or more users are not recognized by the vicinity situation recognizer,
the driving controller determines that the predetermined condition has been satisfied.

4. The vehicle control device according to claim 3,
wherein, when a predetermined user or all users among the one or more users are in a predetermined state in the first predetermined period, the driving controller is configured to cause the vehicle to execute an action different from that when not in the predetermined state.

5. The vehicle control device according to claim 4,
wherein the predetermined state is a state (hereinafter, a first state) in which at least one user among the one or more users has performed a predetermined gesture,
a state (hereinafter, a second state) in which at least one user among the one or more users falls to a ground and is in a prone state in a third predetermined period or more, or
a state (hereinafter, a third state) in which at least one user among the one or more users is estimated to be damaged by a person different from the one or more user or an object.

6. The vehicle control device according to claim 5,
wherein the driving controller, in the first state, is configured to cause the vehicle to continue traveling, cause the vehicle to further travel in a predetermined route, and cause the vehicle to return to near a position at which the user is present.

7. The vehicle control device according to claim 5,
wherein the predetermined gesture is a gesture indicating that the user has left something in the vehicle or a gesture calling the vehicle back.

8. The vehicle control device according to claim 5, further comprising:
a communicator configured to communicate with a predetermined terminal device,
wherein the driving controller is configured transmit information on the predetermined state to the predetermined terminal device using the communicator when the user is in any predetermined state among the second state or the third state.

9. The vehicle control device according to claim 5,
wherein the driving controller is configured to cause an outputter that is configured to output information to output information on the predetermined state when the user is in any predetermined state among the second state or the third state.

10. The vehicle control device according to claim 2,
wherein the vicinity situation recognizer is configured to continue processing of monitoring the one or more users in the first predetermined period in the automated entrance processing.

11. The vehicle control device according to claim 2,
wherein the driving controller is configured to cause the vehicle to travel at the first speed in the first predetermined period, and cause the vehicle to travel at the second speed higher than the first speed after the first predetermined period has elapsed in automated entrance processing for causing the vehicle to enter the parking lot by the driving control after only a driver gets on the vehicle and the driver gets off the vehicle.

12. A monitoring system comprising:
the vehicle control device according to claim 1, and
a monitor configured to monitor an action of a user on the basis of an image captured by an imager that captures an image of the user who gets off the vehicle,
wherein, when the monitor recognizes that the user is in a predetermined state, the driving controller is configured to cause the vehicle to execute an action different from when not in the predetermined state.

13. A vehicle control method comprising:
by one or more control device,
recognizing a vicinity situation of a vehicle;
performing driving control on steering and acceleration or deceleration of the vehicle on the basis of the recognized vicinity situation,
causing the vehicle to travel with a first behavior in a first predetermined period from a first timing at which the vehicle has started after the predetermined event to a second timing at which a predetermined condition is satisfied, and
causing the vehicle to travel with a second behavior in which a proceeding distance per unit time is longer than with the first behavior after the first predetermined period has elapsed in processing of the driving control after a predetermined event of the vehicle.

14. A non-transitory computer-readable storage medium that stores a computer program to be executed by a computer to perform at least:
recognize a vicinity situation of a vehicle;
perform driving control on steering and acceleration or deceleration of the vehicle on the basis of the recognized vicinity situation,
cause the vehicle to travel with a first behavior in a first predetermined period from a first timing at which the vehicle has started after the predetermined event to a second timing at which a predetermined condition is satisfied; and
cause the vehicle to travel with a second behavior in which a proceeding distance per unit time is longer than with the first behavior after the first predetermined period has elapsed in processing of the driving control after a predetermined event of the vehicle.
